(19) United States
(12) Patent Application Publication
(10) Pub. No.: US 2024/0239312 A1
(43) Pub. Date: Jul. 18, 2024

(54) BRAKE CONTROL DEVICE AND BRAKE CONTROL METHOD

(71) Applicant: Hitachi Astemo, Ltd., Hitachinaka-shi, Ibaraki (JP)

(72) Inventors: Takahiro ITO, Tokyo (JP); Takuya USUI, Hitachinaka-shi (JP); Daisuke GOTO, Hitachinaka-shi (JP)

(73) Assignee: Hitachi Astemo, Ltd., Hitachinaka-shi, Ibaraki (JP)

(21) Appl. No.: 18/561,450

(22) PCT Filed: Apr. 26, 2022
(86) PCT No.: PCT/JP2022/018824

§ 371 Date: Nov. 16, 2023

(30) Foreign Application Priority Data
May 27, 2021 (JP) 2021-089222

(51) Int. Cl. B60T 7/12; B60T 8/171; B60T 8/172; B60T 8/24; B60T 8/28

(52) U.S. Cl. CPC B60T 7/12; B60T 8/171; B60T 8/172; B60T 8/24; B60T 8/28; B60Y 2400/81

(57) ABSTRACT

Provided is a high-performance brake control device capable of effectively suppressing a vehicle body vibration generated during traveling on a road with a step or roughness. The brake control device includes a traveling environment estimation unit that estimates a traveling environment from a behavior of a first wheel that is any one of a plurality of wheels provided in a vehicle, and a timing calculation unit that calculates a timing at which a second wheel different from the first wheel is affected by the traveling environment, based on a vehicle speed. The plurality of wheels includes any one wheel that is controlled as for braking based on an estimation result of the traveling environment estimation unit and a calculation result of the timing calculation unit.

### TECHNICAL FIELD

The present invention relates to a configuration of a brake control device and control thereof, and particularly relates to a technique effective for suppressing vehicle body vibration generated due to running on a step, roughness, or the like during traveling.

### BACKGROUND ART

Along with the evolution of electronic control suspensions, a development of a vehicle body vibration suppression technique using brake control has been advanced as one of elemental techniques for improving ride quality of an automobile. During traveling on a road with a step or roughness, a small vibration is controlled by engine torque, and a great vibration is controlled by brake control so that ride comfort is improved.

A background art of the present technical field includes, for example, a technique as disclosed in PTL 1. PTL 1 discloses a control device for an electric brake for mitigating impact during running over a step.

In this conventional technique (PTL 1), when a step is detected by a road surface detection sensor, the braking amount and timing of a brake are calculated, and the brake is applied to all wheels before a vehicle runs over the step, and the vehicle runs over the step in a nose-up state, thereby mitigating the impact during running over the step.

Further, PTL 2 discloses a brake control device capable of suppressing a large vehicle behavior.

In the related art (PTL 2), a pitch movement is suppressed not by the operation of a shock absorber but by braking the wheels in accordance with a change in a pitch angular velocity of the vehicle.

### CITATION LIST

### Patent Literature

PTL 1: JP 2003-72535 A
PTL 2: JP 2011-140303 A

### SUMMARY OF INVENTION

### Technical Problem

An electric brake device to which the control as described in PTL 1 and PTL 2 is applied includes a mechanism having a power source for pressing a brake pad against a disc in order to generate a braking force without the operation of a brake pedal performed by a driver.

The mechanism includes a power mechanism that is configured by a motor and a speed reducer provided in each wheel and is pressed by a piston that is linearly moved by a rotational-linear motion conversion mechanism, and a hydraulic mechanism that is configured by an electric pump and a valve and is pressed by a piston that is linearly moved by hydraulic pressure.

In these systems, a brake control device calculates a control amount such as a required braking force generated in each wheel in accordance with the behavior of a vehicle, the hydraulic mechanism and the power mechanism are controlled based on the control amount, and the brake pad generates a braking force on the wheels.

In the case of such a configuration, in response to a braking command for driving the motor in accordance with the required braking force and generating a force for pressing the piston, a delay may occur a transmission delay of the hydraulic pressure, or the like until the braking force reaches the strength required by the command due to a response delay of the motor.

Therefore, in the methods disclosed in PTL 1 and PTL 2, since braking is not executed for roughness such as a step at an appropriate timing, an impact mitigation effect and a pitch suppression effect cannot be sufficiently obtained, and further a driver may feel uncomfortable about generation of a braking force at a timing not related to passage through the step.

Therefore, a main object of the present invention is to provide a high-performance brake control device and a brake control method capable of effectively suppressing vehicle body vibration generated during traveling on a road with a step or roughness.

### Solution to Problem

In order to solve the above problems, the present invention is configured to include a traveling environment estimation unit that estimates a traveling environment from a behavior of a first wheel that is any one of a plurality of wheels provided in a vehicle, and a timing calculation unit that calculates a timing at which a second wheel different from the first wheel is affected by the traveling environment, based on a vehicle speed. The plurality of wheels includes any one wheel that is controlled as for braking based on an estimation result of the traveling environment estimation unit and a calculation result of the timing calculation unit.

Further, the present invention is configured to include (a) detecting a vertical movement of a first wheel and estimating a step or roughness of a road surface based on detected data, (b) estimating a brake response delay, (c) estimating a time between passage of the first wheel through and arrival of a second wheel at the step or the roughness estimated in the step (a), (d) selecting a braking wheel to be braked, based on a traveling direction of a vehicle and a state of the first wheel, (e) calculating a braking force to be applied to the braking wheel selected in the step (d) when the second wheel arrives at the step or the roughness, (f) calculating a braking start timing of the braking wheel based on the brake response delay estimated in the step (b) and the time estimated in the step (c), and (g) applying the braking force calculated in the step (e) to the braking wheel at the braking start timing calculated in the step (f).

### Advantageous Effects of Invention

According to the present invention, it is possible to achieve a high-performance brake control device and a brake control method capable of effectively suppressing vehicle body vibration generated during traveling on a road with a step or roughness.

As a result, effects such as an improvement in traveling safety by suppressing a change in a driver's viewpoint, an improvement in ride comfort by suppressing a vehicle body vibration, and a reduction of carsickness are expected.

Problems, configurations, and effects other than those described above will be clarified by the following description of embodiments.

### BRIEF DESCRIPTION OF DRAWINGS

FIG. 1 is a diagram illustrating a schematic configuration of a vehicle brake device according to a first embodiment of the present invention.

FIG. 2 is a diagram illustrating a schematic configuration of a braking mechanism of the brake device in FIG. 1.

FIG. 3 is a side view of a vehicle illustrating a vehicle body behavior in a case where only front wheels are braked.

FIG. 4 is a side view of the vehicle illustrating a vehicle body behavior in a case where only rear wheels are braked.

FIG. 5 is a block diagram illustrating control by a vehicle brake control device according to the first embodiment of the present invention.

FIG. 6 is a flowchart illustrating a control method of the vehicle brake device according to the first embodiment of the present invention.

FIG. 7 is a block diagram illustrating control by a vehicle brake device according to a second embodiment of the present invention.

FIG. 8 is a flowchart illustrating a control method of the vehicle brake device according to the second embodiment of the present invention.

FIG. 9 is a side view of a vehicle including a front recognition device according to a third embodiment of the present invention.

FIG. 10 is a block diagram illustrating control by the vehicle brake device according to the third embodiment of the present invention.

FIG. 11 is a flowchart illustrating a control method of the vehicle brake device according to the third embodiment of the present invention.

### DESCRIPTION OF EMBODIMENTS

Hereinafter, embodiments of the present invention will be described with reference to the drawings. Note that in the drawings, the same components are denoted by the same reference numerals, and detailed description of overlapping components is omitted. In addition, the present invention is not limited to the following embodiments, and various modifications and application examples are also included in the scope of the technical concept of the present invention.

### First Embodiment

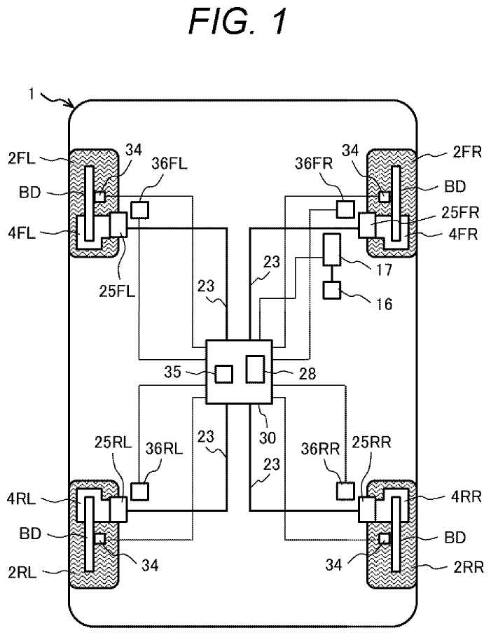

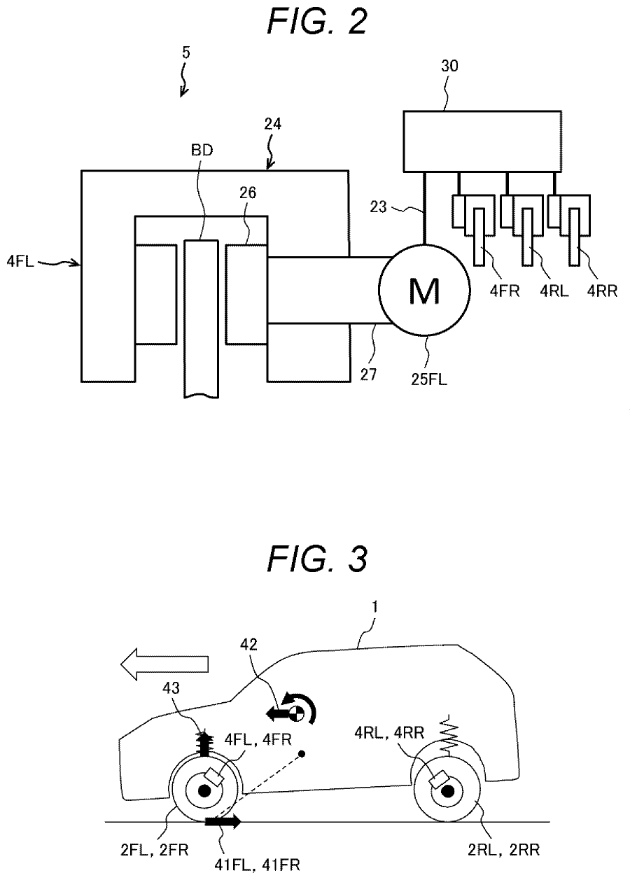

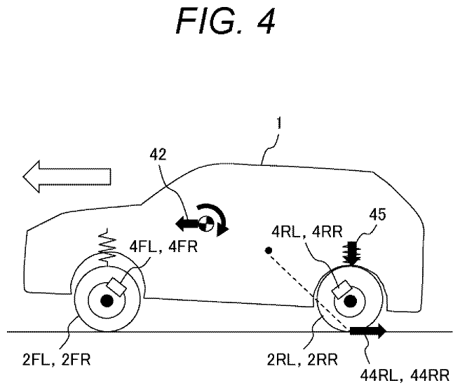

A vehicle brake system according to a first embodiment of the present invention and a control method thereof will be described with reference to FIGS. 1 to 6. FIG. 1 illustrates a schematic configuration of a vehicle brake device of the present embodiment, and FIG. 2 illustrates a schematic configuration of a braking mechanism of FIG. 1. Further, FIGS. 3 and 4 are schematic views of the vehicle as viewed from the side, and illustrate a change in behavior of a vehicle body in a case where front wheels or rear wheels are braked.

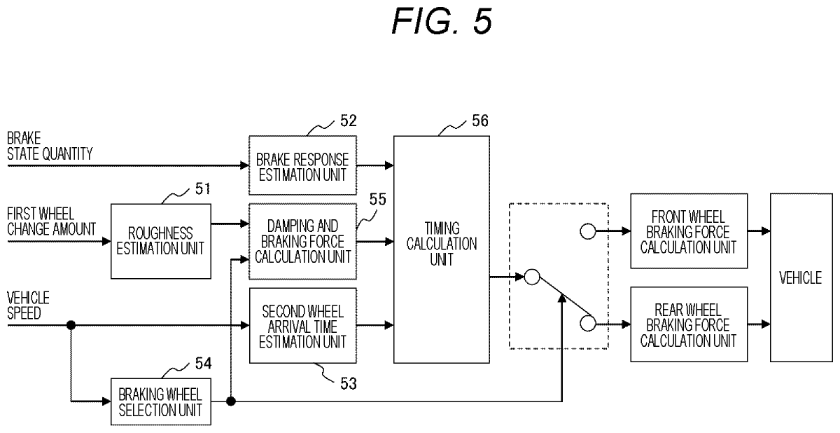

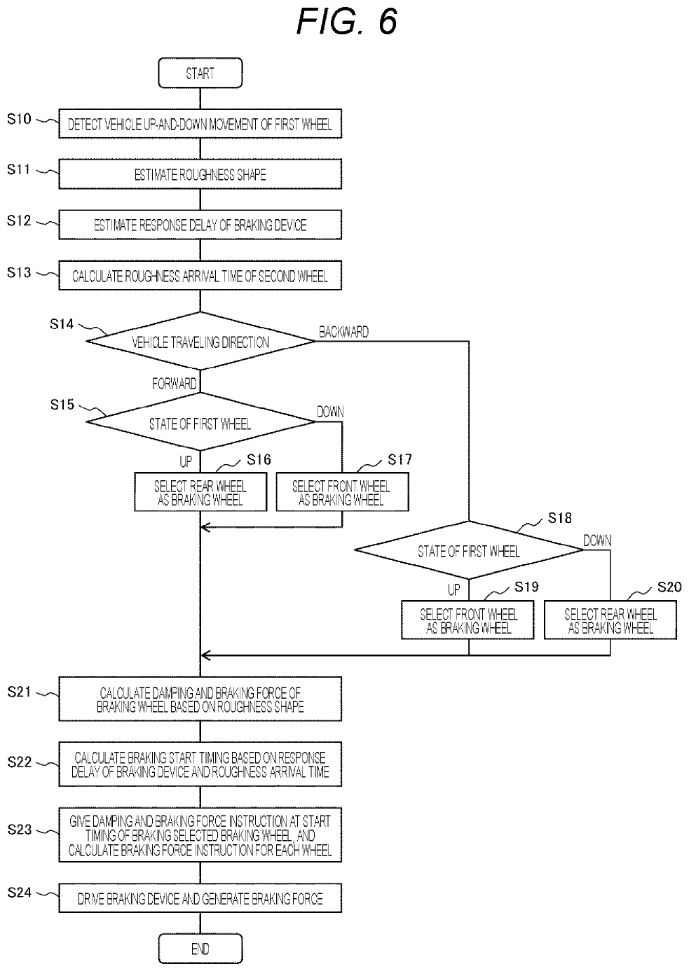

FIG. 5 is a block diagram illustrating control performed by the brake control device of the present embodiment, and FIG. 6 is a flowchart illustrating a control method thereof.

As illustrated in FIGS. 1 and 2, a vehicle 1 of the present embodiment includes a pair of front wheels 2FL and 2FR, a pair of rear wheels 2RL and 2RR, and braking mechanisms 4FL, 4FR, 4RL, and 4RR that apply braking forces to the front wheels 2FL and 2FR and the rear wheels 2RL and 2RR, respectively.

A braking mechanism 5 of the vehicle 1 includes an electric disc brake (electric brake mechanism) that is operated by rotation of the brake electric motors 25FL, 25FR, 25RL, and 25RR to sandwich a brake disc BD. A brake control device 30 that independently controls the electric brake mechanisms of the four wheels and adjusts the braking forces generated by the vehicle 1 is further provided.

Here, the electric brake mechanisms of the four wheels have the same configuration. For example, as in a schematic diagram of the braking mechanism 4FL of the left front wheel illustrated in FIG. 2, in an electric mechanism 24, a brake pad 26 is pressed against the brake disc BD by the brake electric motor 25FL, and a pressing force is generated to generate a braking force. The rotational force of the brake electric motor 25FL is converted into a linear motion by a rotational-linear motion conversion mechanism 27, and presses the brake pad 26 against the brake disc BD to apply the braking force.

Further, In order to adjust the pressing force of the brake pad 26, the rotation of the brake electric motor 25FL is controlled by a drive circuit 28 provided in the brake control device 30, based on the pressing force estimated from a motor current value detected by a current sensor, not illustrated, or detected by a thrust sensor, not illustrated. The rotational-linear motion conversion mechanism 27 employs, for example, a feed screw mechanism to convert rotational motion into linear motion.

Furthermore, the brake control device 30 and the electric brake mechanism are connected by a control signal line 23. The control signal line 23 serves to input control command information from the brake control device 30 to the electric brake mechanism and output driving state information such as a pressing force of the electric brake mechanism and a current value of the brake electric motor 25FL to the brake control device 30.

As illustrated in FIG. 1, operation amount information about a brake pedal 16 (a stroke, a tread force of a brake pedal, etc.) detected by a brake operation sensor 17 is transmitted to the brake control device 30. Further, wheel rotational speed sensors 34 are attached to the front wheels 2FL and 2FR and the rear wheels 2RL and 2RR of the vehicle 1, respectively, and transmit wheel speed information to the brake control device 30.

Further, a vehicle motion sensor 35 is also installed in the brake control device 30. The vehicle motion sensor 35 detects vehicle behavior information such as an acceleration and a yaw rate of the vehicle 1 and transmits the vehicle behavior information to the brake control device 30. In addition, vehicle body vertical movement sensors 36FL, 36FR, 36RL, and 36RR are installed on the vehicle body side near the wheels of the vehicle 1 to detect the vertical movement of the vehicle body and transmit the vertical movement to the brake control device 30. The vehicle body vertical movement sensors 36FL, 36FR, 36RL, and 36RR detect, for example, a vertical speed, acceleration, and position of the vehicle body.

In the brake control device 30 mounted on such a vehicle 1, a control command is transmitted to the electric brake mechanism provided in each wheel, based on operation information obtained from the stroke, the tread force, and the like of the brake pedal 16 by a driver, wheel speed information about the front and rear wheels obtained from the wheel rotational speed sensor 34, vehicle behavior information about the vehicle 1 obtained from the vehicle motion sensor 35, and the like. Thus, the operations of the braking mechanisms 4FL, 4FR, 4RL and 4RR are controlled.

The brake control device 30 calculates a control amount corresponding to the braking forces at the front wheels 2FL and 2FR and the rear wheels 2RL and 2RR based on the operation information about the brake pedal 16, the wheel speed information and the vehicle behavior information about the vehicle 1, an electric brake mechanism operation state information, and the like, and transmits the control amount to the braking mechanisms 4FL, 4FR, 4RL, and 4RR of the wheels.

The braking mechanisms 4FL, 4FR, 4RL, and 4RR of the wheels control the operations of the brake electric motors 25FL, 25FR, 25RL, and 25RR based on a control amount command value of the brake control device 30 to adjust the braking forces.

The movement of the vehicle body during the operations of the front and rear braking mechanisms 4FL, 4FR, 4RL, and 4RR is described with reference to FIGS. 3 and 4. Note that FIGS. 3 and 4 are views of the vehicle 1 traveling in a left direction in the drawings as viewed from the side.

As illustrated in FIG. 3, when braking forces 41FL and 41FR are generated only by the braking mechanisms 4FL and 4FR of the front wheels 2FL and 2FR, a forward force 42 acts on the center of gravity of the vehicle 1, and the vehicle 1 moves rotationally counterclockwise in the drawing. Thus, the rear portion of the vehicle is lifted.

On the other hand, grounding points of the front wheels 2FL and 2FR move around an instantaneous rotation center determined by the configuration of a suspension. Therefore, although an anti-dive force 43 acts on the vehicle body in a vehicle body upward direction due to the braking forces 41FL and 41FR, the rear portion of the vehicle body is lifted as a whole vehicle.

In addition, as illustrated in FIG. 4, when braking forces 44RL and 44RR are generated only by the braking devices 4RL and 4RR of the rear wheels 2RL and 2RR, the forward force 42 acts on the center of gravity of the vehicle 1 similarly to FIG. 3, and the vehicle 1 moves rotationally counterclockwise in the drawing. Thus, the rear portion of the vehicle is lifted.

However, since an anti-lift force 45 acts on the vehicle body in a vehicle body downward direction due to the braking forces 44RL and 44RR acting on the grounding points of the rear wheels 2RL and 2RR moving around the instantaneous rotation center determined by the configuration of the suspension, the rear portion of the vehicle body is lowered as a whole vehicle.

In the vehicle 1 and the brake device that perform the operations as described above, the braking mechanisms 4FL, 4FR, 4RL, and 4RR generates the braking forces late in response to the command from the brake control device 30 due to inertia of the brake electric motors 25FL, 25FR, 25RL, and 25RR, friction of the rotational-linear motion conversion mechanism 27, a gap between the brake pad 26 and the brake disc BD, and the like.

With reference to FIGS. 5 and 6, a description will be given of control performed by the brake control device 30 for the purpose of suppressing a vehicle body vibration generated during the passing through a step or roughness in a case where the step or roughness exist in the traveling direction of the vehicle 1.

A control block diagram of FIG. 5 illustrates an example of a control block mounted in the brake control device 30 to realize the control described in the present embodiment. In addition, a control flow illustrated in FIG. 6 indicates the control performed by the brake control device 30 based on a required braking force, and is activated every predetermined time.

### <<Step S10>>

First, in step S10, when the vehicle 1 arrives at a step while traveling forward and the front wheels as first wheels first pass through the step, vertical movements of the first wheels is detected based on values of the vehicle body vertical movement sensors 36FL, 36FR, 36RL, and 36RR, and the processing proceeds to step S11.

### <<Step S11>>

Next, in step S11, a roughness estimation unit 51 estimates a roughness shape of the step based on the data at a time of the first wheels passing through the step, and the processing proceeds to step S12. The data used at this time includes, for example, positions, speeds, and accelerations detected by the vertical movement sensors 36FL, 36FR, 36RL, and 36RR, and differences in the values between the wheels. In addition, the value estimated by the roughness estimation unit 51 includes a height H, a width W, and the like of the roughness.

### <<Step S12>>

Next, in step S12, a brake response estimation unit 52 estimates response delays Tb of the braking mechanisms 4FL, 4FR, 4RL, and 4RR, and the processing proceeds to step S13. For this estimation, for example, information on response delays of the braking mechanisms 4FL, 4FR, 4RL, and 4RR stored in advance in the brake control device 30 may be used. Alternatively, the time until the gap between the brake pad 26 and the brake disc BD is closed and the brake pad 26 is pressed may be obtained from the value of the gap between the brake pad 26 and the brake disc BD and the rotational speed of the electric motor 25.

### <<Step S13>>

Next, in step S13, a second wheel arrival time estimation unit 53 estimates a time Tc from passing of the first wheels to arrival of the second wheels at the step. For example, the time Tc may be obtained as Tc=L/Ts using a wheelbase value L of the vehicle 1 and speed information about the vehicle 1.

### <<Step S14>>

Next, in step S14, the traveling direction of the vehicle 1 is determined based on the vehicle speed. In a case where the traveling direction is forward, the processing proceeds to step S15, and in a case where the traveling direction is backward, the processing proceeds to step S18.

### <<Step S15>>

In step S15, a braking wheel selection unit 54 determines the state of a change of the first wheels during forward movement. In a case where the change of the first wheels is lifting, the processing proceeds to step S16, and in a case where the change is lowering, the processing proceeds to step S17.

### <<Step S16>>

In step S16, the braking wheel selection unit 54 selects the rear wheels 2RL and 2RR as the wheels to be braked when the second wheels arrives at the step.

### <<Step S17>>

In step S17, the braking wheel selection unit 54 selects the front wheels 2FL and 2FR as the wheels to be braked when the second wheels arrives at the step.

### <<Step S18>>

In step S18, the braking wheel selection unit 54 determines the state of change of the first wheels during backward movement. In a case where the change of the first wheels is lifting, the processing proceeds to step S19, and in a case where the change is lowering, the processing proceeds to step S20.

### <<Step S19>>

In step S19, the braking wheel selection unit 54 selects the front wheels 2FL and 2FR as the wheels to be braked when the second wheels arrives at the step.

### <<Step S20>>

In step S20, the braking wheel selection unit 54 selects the rear wheels 2RL and 2RR as the wheels to be braked when the second wheels arrives at the step.

### <<Step S21>>

In step S21, a damping and braking force calculation unit 55 calculates braking forces to be applied to the braking wheels when the second wheels arrives at the step. The braking forces are calculated based on the roughness shape estimated in step S11. For example, strength of the braking forces may be determined based on the height H and the width W of the roughness.

### <<Step S22>>

Next, in step S22, a timing calculation unit 56 calculates a braking start timing Ts of the braking wheel based on the response delays Tb of the braking mechanisms 4FL, 4FR, 4RL, and 4RR estimated in step S12 and a roughness arrival time Tc of the second wheels calculated in step S13. For example, the operation may be started earlier by Tb than the arrival of the second wheels arrive at the step, as the timing obtained by Ts=Tc−Tb from the point in time when the first wheels arrive.

### <<Step S23>>

Next, in step S23, a damping and braking force command calculated in step S22 is given to the braking wheels obtained in steps S16, S17, S19, and S20. At this time, in a case where there is a command for generating the braking force by operating the brake pedal 16 or the like in advance, addition of this command may be performed.

### <<Step S24>>

Next, in step S24, the braking mechanisms 4FL, 4FR, 4RL, and 4RR of the wheels generate the braking forces based on the damping braking force commands of the wheels.

With such a flow, the braking mechanisms 4FL, 4FR, 4RL, and 4RR are driven to generate the braking forces respectively for the wheels, and thus the damping and braking force can be applied to the braking wheels without delay at the timing when the second wheels arrives at the step.

In addition, since the roughness shape of the step is estimated when the first wheels pass, it is possible to apply the damping and braking force corresponding to a change amount of the vehicle body when the second wheels pass through the step, and to obtain a high vibration suppression effect.

Further, as described in steps S14 to S20, the braking wheels are changed in accordance with the traveling direction of the vehicle 1 and the direction of change of the first wheels, and thus the damping effect can be obtained when the second wheels arrives at the step.

Further, when the vehicle in the flow of step S16 moves forward and the first wheels are lifted, the second wheels are also expected to be lifted. Therefore, the rear portion of the vehicle body is lowered by braking the rear wheels by the braking mechanisms 4RL and 4RR at the timing when the second wheels are lifted, and this provides the effect of suppressing the fluctuation of the vehicle body due to the lifting of the second wheels.

Further, when the vehicle in the flow of step S17 moves forward and the first wheels are lowered, the second wheels are also expected to be lowered. Therefore, the rear portion of the vehicle body is lifted by braking the front wheels by the braking mechanisms 4FL and 4FR at the timing when the second wheels are lowered, and this provides the effect of suppressing the fluctuation of the vehicle body due to the lowering of the second wheels.

Further, when the vehicle in the flow of step S19 moves backward and the first wheels are lifted, the second wheels are also expected to be lifted. Therefore, the front portion of the vehicle body is lowered by braking the front wheels by the braking mechanisms 4FL and 4FR at the timing when the second wheels are lifted, and this provides the effect of suppressing the fluctuation of the vehicle body due to the lift of the second wheels.

Further, when the vehicle in the flow of step S20 moves backward and the first wheels are lowered, the second wheels are also expected to be lowered. Therefore, the front portion of the vehicle body is lifted by braking the rear wheels by the braking mechanisms 4RL and 4RR at the timing when the second wheels are lowered, and this provides the effect of the suppressing fluctuation of the vehicle body due to the lowering of the second wheels.

When the second wheels pass through the step following the first wheels, the execution of this control suppresses the fluctuation of the vehicle body due to the fluctuation of the second wheels. Therefore, the vibration and pitching of the vehicle body are suppressed, thereby making it possible to obtain the effects such as the improvement in the driving safety due to the reduction of the movement of a viewpoint of the driver of the vehicle 1 and the reduction of motion sickness due to the improvement in ride comfort.

Further, in step S13, the time Tc until the second wheels arrives at the step after the first wheels pass through the step is estimated by using the wheelbase value L of the vehicle 1 and the speed information about the vehicle 1. However, in a case where the first wheels diagonally enters the step, a wheel fluctuation occurs in a time shorter than the time Tc estimated from the vehicle speed and the wheelbase L. Therefore, the fluctuation may be determined by using a threshold or the like so as not to be considered to occur due to the fluctuation of the second wheels.

Furthermore, the roughness shape of the step is estimated from the fluctuations of the wheels, and the braking timing is calculated in consideration of the time difference in arrival of the two wheels, which are the second wheels among the front and rear wheels serving, at the step.

As a result, also in a case where the vehicle 1 obliquely enters the step, it is possible to obtain a damping effect substantially similar to the above-described content.

In addition, although the change in the values of the vehicle body vertical movement sensors 36FL, 36FR, 36RL, and 36RR is used for the estimation of the roughness shape, a substantially similar effect can be obtained by estimating the roughness shape of a road surface based on a model of the vehicle 1 also using the wheel measurement, the fluctuation of the vehicle motion sensor 35, and the like.

In addition, in a case where a slip rate of the wheels is greater than a predetermined value, the damping and braking may not be performed in order to avoid wheel locking.

Further, in a case where the wheels to be braked have already been braked at the braking start timing, the braking forces of the wheels at the braking timing may be made greater than before.

As described above, the brake control device of the present embodiment includes a traveling environment estimation unit (roughness estimation unit 51) that estimates a traveling environment from a behavior of a first wheel that is any one of the plurality of wheels 2FL, 2FR, 2RL, and 2RR provided in the vehicle 1, and the timing calculation unit 56 that calculates the timing at which a second wheel different from the first wheel is affected by the traveling environment, based on a vehicle speed. Any one of the plurality of wheels 2FL, 2FR, 2RL, and 2RR is controlled as for braking based on an estimation result of the traveling environment estimation unit (roughness estimation unit 51) and a calculation result of the timing calculation unit 56.

As a result, it is possible to effectively suppress the vehicle body vibration generated during traveling on a road with a step or roughness.

Note that the present embodiment has described the configuration in which the electric disc brake is provided on each of the four wheels as an example, but the same effect can be obtained even in a case where the brake device of the present embodiment is applied to a configuration where a brake pad pressing force due to a pressure of a cylinder provided on each of the four wheels is adjusted by a hydraulic unit including an electric pump and a solenoid valve.

### Second Embodiment

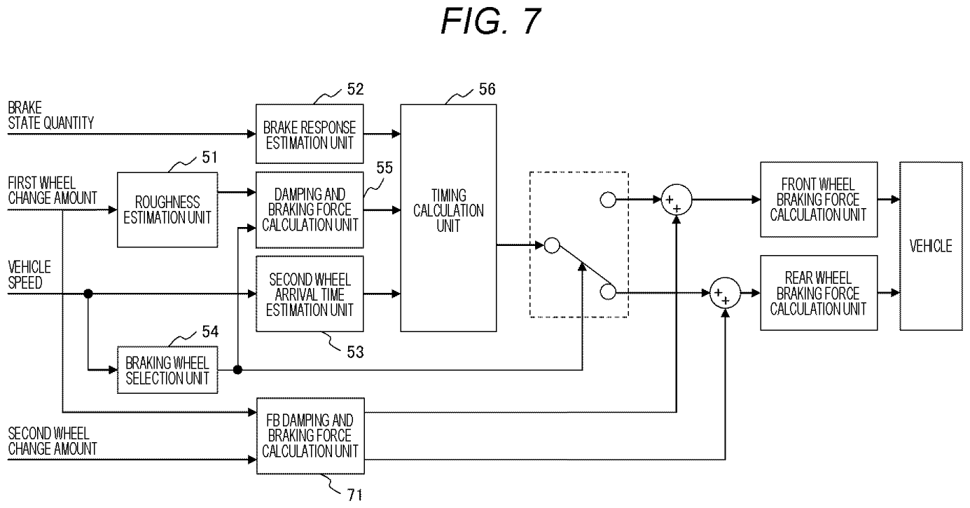

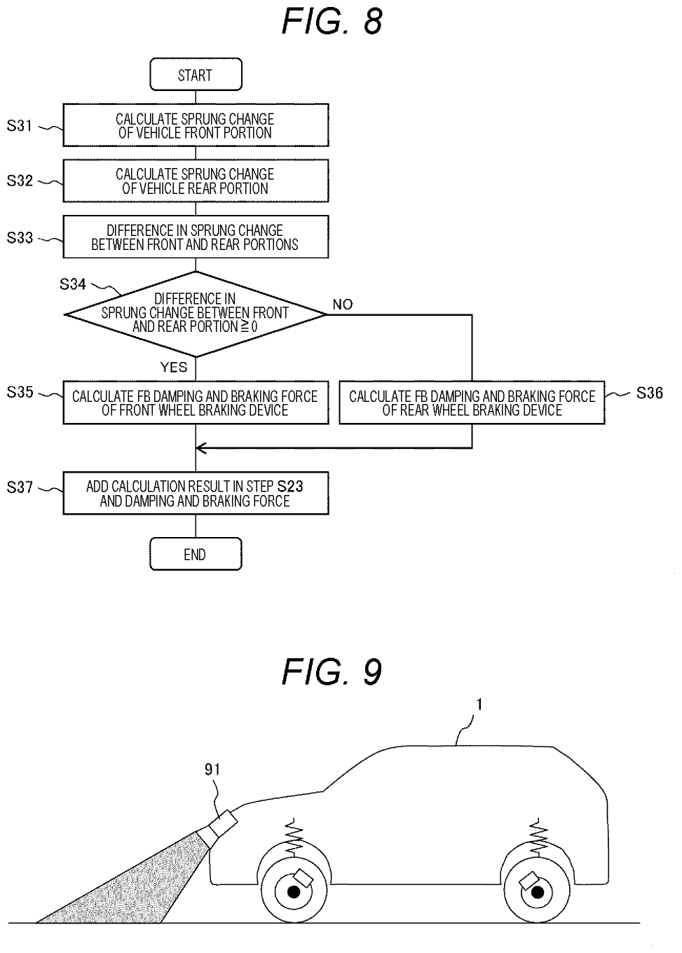

A vehicle brake system according to a second embodiment of the present invention and a control method thereof will be described with reference to FIGS. 7 and 8. FIG. 7 is a block diagram illustrating control performed by the brake control device of the present embodiment, and corresponds to a modification of the first embodiment (FIG. 5). FIG. 8 is a flowchart illustrating the calculation of a feedback (FB) damping and braking force calculation unit 71 which is a part of the control performed by the brake control device of the present embodiment, and the calculation result is added to the calculation result in step S23 of the flowchart (FIG. 6) in the first embodiment.

The control flow of the present embodiment illustrated in FIG. 8 is executed simultaneously with the control flow of the first embodiment illustrated in FIG. 6, and is a portion for calculating an FB damping and braking force to be added to the calculation result in step S23 of FIG. 6. Hereinafter, a control flow of the FB braking force calculation unit 71 will be described.

### <<Step S31>>

First, in step S31, a sprung change of the vehicle front portion is calculated, and the processing proceeds to step S32. Here, the sprung change may be, for example, a vertical speed based on a vertical acceleration detected by an accelerometer installed on a vehicle spring.

### <<Step S32>>

First, in step S32, a sprung change of the vehicle rear portion is calculated, and the processing proceeds to step S33. Here, the sprung change may be, for example, a vertical speed based on a vertical acceleration detected by the accelerometer installed on the vehicle spring.

### <<Step S33>>

First, in step S33, a vehicle sprung change difference is calculated, and the processing proceeds to step S34. Here, the sprung change difference may be a difference in a sprung vertical direction between the front and rear of the vehicle calculated in steps S31 and S32.

### <<Step S34>>

Next, in step S34, a determination is made whether the vehicle sprung change difference is positive or negative. In a case of positive (YES), the processing proceeds to step S35, and in a case of negative (NO), the processing proceeds to step S36.

### <<Step S35>>

In step S35, the damping and braking forces applied respectively to the front wheel braking mechanisms 4FL and 4FR are calculated, and the processing proceeds to step S37. For example, the damping and braking forces may be set to magnitude corresponding to a sprung front-rear change difference.

### <<Step S36>>

In step S36, the damping and braking forces applied respectively to the rear wheel braking mechanisms 4RL and 4RR are calculated, and the processing proceeds to step S37. For example, the damping and braking force may be set to magnitude correlated with a time change of the sprung front-rear change difference.

### <<Step S37>>

In step S37, addition to the calculation result of step S23 in FIG. 6 is performed, and an added result is given as the damping and braking force command. Then, the processing proceeds to step S24 of FIG. 6, and the braking mechanisms 4FL, 4FR, 4RL, and 4RR of the wheels are controlled so that the braking force is generated.

In the present embodiment, the damping and braking forces where the sprung changes of the front and rear portions are fed back (FB) are applied. Although the damping effect at a time when the first wheels pass through a step is small due to the brake response delay, the damping and braking forces using the information about the first wheels is also applied when the second wheels pass through the step. Thus, the vehicle body damping effect equivalent to that described in the first embodiment can be obtained.

Further, as in the first embodiment, the vehicle body damping effect makes it possible to obtain effects such as an improvement in driving safety due to a reduction of the movement of a driver's viewpoint and a reduction of carsickness due to an improvement in ride comfort.

### Third Embodiment

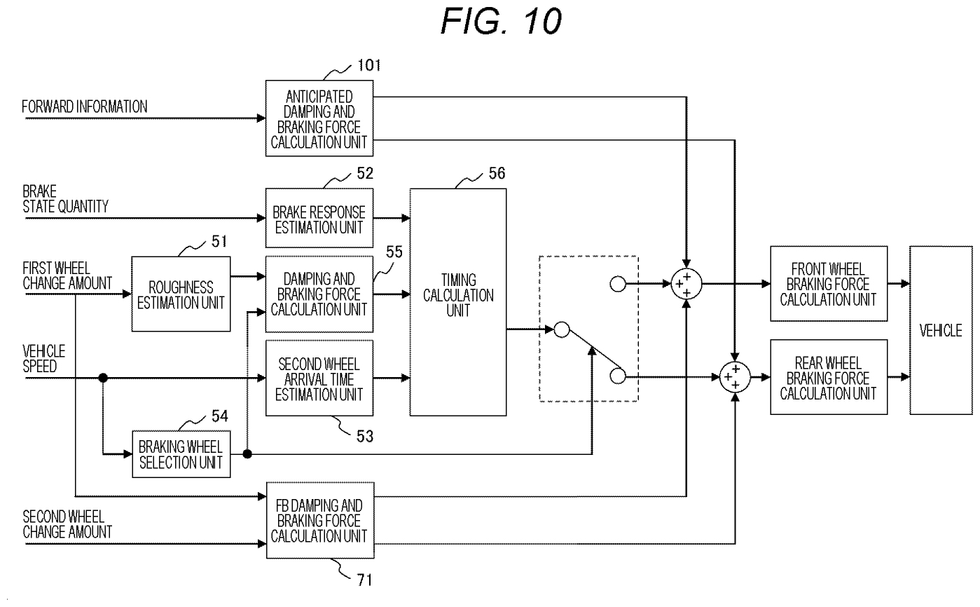

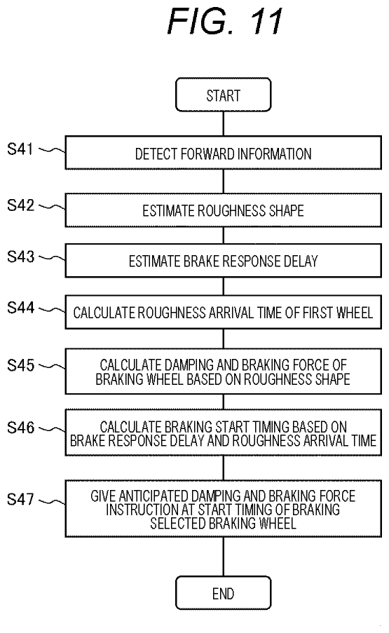

A vehicle brake system according to a third embodiment of the present invention and a control method thereof will be described with reference to FIGS. 9 to 11. FIG. 9 is a side view of the vehicle 1, and includes a front recognition device 91 at a front portion of the vehicle. FIG. 10 is a block diagram illustrating control performed by the brake control device of the present embodiment, and corresponds to a modification of the second embodiment (FIG. 7). FIG. 11 is a flowchart illustrating calculation of an anticipated damping and braking force calculation unit 101 which is a part of the control performed by the brake control device of the present embodiment, and this calculation result is added to the calculation result in step S23 of the flowchart (FIG. 6) in the first embodiment.

A control flow of the present embodiment illustrated in FIG. 11 is executed simultaneously with the control flow of the first embodiment illustrated in FIG. 6, and is a portion for calculating an anticipated damping and braking force to be added to the calculation result in step S23 of FIG. 6. Hereinafter, a control flow of the anticipated braking force calculation unit 101 will be described.

### <<Step S41>>

First, in step S41, the front recognition device 91 detects front information, and the processing proceeds to step S42. Here, the front recognition device 91 is a device, such as a camera or a laser displacement meter, capable of detecting front road surface information, and the front information may be image data, time-series displacement data, or the like.

### <<Step S42>>

Next, in step S42, a roughness shape of a step is estimated based on the front information, and the processing proceeds to step S43. For example, it is assumed that information including the height H, the width W, and the like of the roughness is estimated based on the image and the displacement data detected in step S41.

### <<Step S43>>

Next, in step SS43, the brake response estimation unit 52 estimates the response delays Tb of the braking mechanisms 4FL, 4FR, 4RL, and 4RR, and the processing proceeds to step S44. In this estimation, for example, information on the response delays of the braking mechanisms 4FL, 4FR, 4RL, and 4RR stored in advance in the brake control device 30 may be used. Alternatively, the time until the gap between the brake pad 26 and the brake disc BD is closed and the brake pad 26 is pressed may be obtained from the value of the gap between the brake pad 26 and the brake disc BD and the rotational speed of the brake electric motors 25FL, 25FR, 25RL, and 25RR.

### <<Step S44>>

Next, in step S44, the time until the step or the roughness of the road surface detected by the front recognition device 91 arrives at the first wheels is estimated, and the processing proceeds to step S45. This time may be obtained by using, for example, the detection position of the front recognition device 91, the distance up to the vehicle 1, and the speed information about the vehicle 1.

### <<Step S45>>

Next, in step S45, a braking wheel to which the damping and braking force is applied when the first wheels arrive at the step or the roughness is selected in accordance with the step or the roughness shape of the road surface, and the anticipated damping and braking forces to be applied to the braking wheels when the first wheels arrives at the step or the roughness are calculated. Then, the processing proceeds to step S46. The anticipated damping and braking forces are calculated based on the roughness shape estimated in step S42. For example, strength of the braking force may be determined based on the height H and the width W of the roughness.

### <<Step S46>>

Next, in step S46, the braking start timing of the braking wheels at a time when the first wheels arrives at the step is calculated based on the response delays of the braking mechanisms 4FL, 4FR, 4RL, and 4RR estimated in step S43 and the roughness arrival time of the first wheels calculated in step S44, and the processing proceeds to step S47. For example, the operation may be started earlier by the response delays of the braking mechanisms 4FL, 4FR, 4RL, and 4RR than the arrival of the first wheels at the step after a point in time when the front recognition device 91 recognizes the roughness.

### <<Step S47>>

Next, in step S47, the anticipated braking force command calculated in step S45 is given to the braking wheels at the timing calculated in step S46. Thereafter, addition of the calculation result in step S23 in FIG. 6 is performed, and an added result is given as the damping and braking force command. Then, the processing proceeds to step S24 of FIG. 6, and the braking mechanisms 4FL, 4FR, 4RL, and 4RR of the wheels are controlled so that the braking forces are generated.

In the present embodiment, in addition to the configuration of the second embodiment, the anticipated damping and braking forces using vehicle front information obtained by the front recognition device 91 can be applied.

As a result, since the damping control at a time when the first wheels pass through the step is performed in consideration of the brake response delays, a high damping effect can be obtained. Further, the damping and braking forces using the information about the first wheels are also applied when the second wheels pass through the step. Thus, the vehicle body damping effect equivalent to that described in the first and second embodiments can be obtained.

This makes it possible, as in the first and second embodiments, to obtain effects such as an improvement in driving safety due to a reduction of the movement of a driver's viewpoint and a reduction of carsickness due to an improvement in ride comfort.

Note that the present invention is not limited to the above-described embodiments, and includes various modifications. For example, the above-described embodiments have been described in detail for easy understanding of the present invention, and are not necessarily limited to those having all the described configurations. Further, a part of the configuration of one embodiment can be replaced with the configuration of another embodiment, and the configuration of the other embodiments can be added to the configuration of one embodiment. In addition, the other configurations can be added to, deleted from a part of the configuration in each embodiment, and a part of the configuration in each embodiment can be replaced with the other configurations.

### REFERENCE SIGNS LIST

1 vehicle
2FL, 2FR (pair of) front wheels
2RL, 2RR (pair of) rear wheels
4FL, 4FR, 4RL, 4RR, 5 braking mechanism (electric disc brake)
16 brake pedal
17 brake operation sensor
23 control signal line
24 electric mechanism
25FL, 25FR, 25RL, 25RR brake electric motor
26 brake pad
27 rotational-linear motion conversion mechanism
28 drive circuit
30 brake control device
34 wheel rotational speed sensor
35 vehicle motion sensor
36FL, 36FR, 36RL, 36RR vehicle body vertical movement sensor
41FL, 41FR, 44RL, 44RR braking force
42 forward force
43 anti-dive force
45 anti-lift force
51 roughness estimation unit
52 brake response estimation unit
53 second wheel arrival time estimation unit
54 braking wheel selection unit
55 damping and braking force calculation unit
56 timing calculation unit
71 FB damping and braking force calculation unit
91 front recognition device
101 anticipated damping and braking force calculation unit
BD brake disc

1. A brake control device comprising:
a traveling environment estimation unit that estimates a traveling environment from a behavior of a first wheel that is any one of a plurality of wheels provided in a vehicle; and
a timing calculation unit that calculates a timing at which a second wheel different from the first wheel is affected by the traveling environment, based on a vehicle speed,
wherein the plurality of wheels includes any one wheel that is controlled as for braking based on an estimation result of the traveling environment estimation unit and a calculation result of the timing calculation unit.

2. The brake control device according to claim 1, wherein the traveling environment includes a step or roughness of a road surface.

3. The brake control device according to claim 1,
wherein in a case where the first wheel that is a front wheel is lifted during forward movement of the vehicle, a rear wheel is braked at the timing, and
wherein in a case where the front wheel is lowered, the front wheel is braked at the timing.

4. The brake control device according to claim 1,
wherein in a case where the first wheel that is a rear wheel is lifted during backward movement of the vehicle, a front wheel is braked at the timing, and
wherein in a case where the rear wheel is lowered, the rear wheel is braked at the timing.

5. The brake control device according to claim 1, wherein the timing calculation unit calculates the timing based on a wheelbase of the vehicle and the vehicle speed.

6. The brake control device according to claim 1, wherein the traveling environment estimation unit estimates the traveling environment based on a vertical change amount of the vehicle.

7. The brake control device according to claim 1, wherein in a case where the plurality of wheels includes a wheel braked at the timing and a slip ratio of the wheel is equal to or greater than a predetermined value, braking at the timing is stopped.

8. The brake control device according to claim 1, wherein in a case where the plurality of wheels includes a wheel to be braked and the wheel is already braked at the timing, a braking force of the wheel is further increased at the timing.

9. The brake control device according to claim 1,
wherein the vehicle includes a front information acquisition unit that acquires front information,
wherein the plurality of wheels includes a braking wheel to be braked that is selected and whose braking timing and braking amount are calculated based on road surface information acquired based on the front information, and
wherein the braking wheel is controlled as for braking at the calculated timing.

10. A brake control method comprising:
(a) detecting a vertical movement of a first wheel and estimating a step or roughness of a road surface based on detected data;
(b) estimating a brake response delay;
(c) estimating a time between passage of the first wheel through and arrival of a second wheel at the step or the roughness estimated in the step (a);
(d) selecting a braking wheel to be braked, based on a traveling direction of a vehicle and a state of the first wheel;
(e) calculating a braking force to be applied to the braking wheel selected in the step (d) when the second wheel arrives at the step or the roughness;
(f) calculating a braking start timing of the braking wheel based on the brake response delay estimated in the step (b) and the time estimated in the step (c); and
(g) applying the braking force calculated in the step (e) to the braking wheel at the braking start timing calculated in the step (f).

11. The brake control method according to claim 10, further comprising:
(h) calculating sprung changes of a front portion and a rear portion of the vehicle;
(i) calculating a vehicle sprung front-rear change difference from the sprung changes of the front portion and the rear portion of the vehicle, the sprung changes being calculated in the step (h); and
(j) determining whether the vehicle sprung front-rear change difference calculated in the step (i) is positive or negative, calculating a braking force to be applied to a front wheel of the vehicle in a case of positive, and calculating a braking force to be applied to a rear wheel of the vehicle in a case of negative,
wherein in the step (g), the braking force calculated in the step (j) is added to the braking force calculated in the step (e).

12. The brake control method according to claim 10, further comprising:
(k) detecting front information and estimating the step or the roughness of the road surface based on the detected front information;
(l) estimating a brake response delay;
(m) estimating a time until the step or the roughness estimated in the step (k) arrives at the first wheel;
(n) selecting a braking wheel that applies a braking force when the first wheel arrives at the step or the roughness in accordance with the step or the roughness estimated in the step (k), and calculating an anticipated damping and braking force to be applied to the braking wheel; and
(o) calculating a braking start timing of the braking wheel based on the brake response delay estimated in the step (1) and the time estimated in the step (m),
wherein in the step (g), the anticipated damping and braking force calculated in the step (n) is added to the braking force calculated in the step (e).
